(19) United States
(12) Patent Application Publication
(10) Pub. No.: US 2024/0313948 A1
(43) Pub. Date: Sep. 19, 2024

(54) DETERMINISTIC LOCAL KEY MASKING FOR HIGH-SPEED ENCRYPTION WITH KEY REUSE

(71) Applicant: QUALCOMM Incorporated, San Diego, CA (US)

(72) Inventors: Nicolas Thaddee COURTOIS, Mougins (FR); Matthew MCGREGOR, Huntington Beach, CA (US)

(21) Appl. No.: 18/183,068

(22) Filed: Mar. 13, 2023

(51) Int. Cl. H04L 9/08; G11C 13/00; H03M 13/19

(52) U.S. Cl. CPC H04L 9/08; G11C 13/0026; H03M 13/19

(57) ABSTRACT

Systems and techniques are provided for secure confidential data transmission and secure execution of a cryptographic function (e.g., inside a system-on-a-chip (SoC)). The systems and techniques can be used for secure data encryption and decryption in the presence of physical side channel information leakage. For example, a process can include obtaining a multi-bit input including a plurality of bits. A masking engine can be used to generate a plurality of shares based on the multi-bit input. The masking engine can be a deterministic masking engine. The plurality of shares can be multi-bit shares. The plurality of shares can be transmitted to a cryptographic engine, wherein the plurality of shares jointly represent the multi-bit input based on an exclusive or (XOR) between each respective share of the plurality of shares.

### FIELD OF THE DISCLOSURE

The present disclosure generally relates to cryptographic encryption and decryption. For example, aspects of the present disclosure relate to performing deterministic masking for multiple bits.

### BACKGROUND OF THE DISCLOSURE

Computing devices often employ various techniques to protect data. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, etc. Certain scenarios exist in which attacks are performed in an attempt to obtain such security information assets. Accordingly, it is often advantageous to implement systems and techniques to protect such security information assets.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing deterministic masking for groups of multiple bits used in encryption with key reuse. According to at least one illustrative example, a method for data access is provided. The method may include: obtaining a multi-bit input including a plurality of bits; generating, using a masking engine, a plurality of shares based on the multi-bit input; and transmitting, to a cryptographic engine, the plurality of shares, wherein the plurality of shares jointly represent the multi-bit input based on an exclusive or (XOR) between each respective share of the plurality of shares.

In another example, an apparatus for data access is provided that includes at least one memory and at least one processor coupled to the at least one memory. The at least one processor is configured to and can: obtain a multi-bit input including a plurality of bits; generate, using a masking engine, a plurality of shares based on the multi-bit input; and transmit, to a cryptographic engine, the plurality of shares, wherein the plurality of shares jointly represent the multi-bit input based on an exclusive or (XOR) between each respective share of the plurality of shares.

In another example, a non-transitory computer-readable medium of an apparatus is provided that has stored thereon instructions that, when executed by one or more processors, cause the one or more processors to: obtain a multi-bit input including a plurality of bits; generate, using a masking engine, a plurality of shares based on the multi-bit input; and transmit, to a cryptographic engine, the plurality of shares, wherein the plurality of shares jointly represent the multi-bit input based on an exclusive or (XOR) between each respective share of the plurality of shares.

In another example, an apparatus for data access is provided. The apparatus includes: means for obtaining a multi-bit input including a plurality of bits; means for generating, using a masking engine, a plurality of shares based on the multi-bit input; and means for transmitting, to a cryptographic engine, the plurality of shares, wherein the plurality of shares jointly represent the multi-bit input based on an exclusive or (XOR) between each respective share of the plurality of shares.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating certain components of a computing device, in accordance with some examples;

FIG. 2A is a diagram illustrating an example of bit-level masking using two shares, in accordance with some examples;

FIG. 2B is a diagram illustrating an example of shares utilized by an Advanced Encryption Standard (AES) engine, in accordance with some examples;

FIG. 3 is a diagram illustrating an example of a deterministic masking engine, in accordance with some examples;

FIG. 4 is a diagram illustrating an example of a deterministic masking engine implementing a deterministic update for shares utilized by an AES engine, in accordance with some examples;

FIG. 5 is a flow chart illustrating an example of a process for data access, in accordance with some examples; and

FIG. 6 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As used herein, the phrase operatively connected, or operative connection (or any variation thereof), means that there exists between elements/components/devices, etc. a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection. Additionally, operatively connected devices and/or components may exchange things, and/or may inadvertently share things, other than information, such as, for example, electrical current, radio frequency signals, power supply interference, interference due to proximity, interference due to re-use of the same wire and/or physical medium, interference due to re-use of the same register and/or other logical medium, etc.

Cryptographic ciphers can be used for encryption and decryption of electronic data. A symmetric cryptographic cipher uses the same key (e.g., referred to as a secret key or a private key) for encryption and decryption. An asymmetric cryptographic cipher uses a private key and a public key shared between parties. Asymmetric cryptographic ciphers can also be referred to as public-key cryptography (PKC). Examples of symmetric cryptographic ciphers include Advanced Encryption Standard (AES), Data Encryption Standard (DES), Blowfish, and International Data Encryption Algorithm (IDEA), among various others. In some examples, symmetric ciphers such as AES can be used to implement fast and efficient encryption and decryption. However, because the same key is used for encryption and decryption, the private keys of a symmetric cipher must be distributed to the parties in a way that safeguards the secrecy of the private keys. For example, PKC or asymmetric cipher techniques are often used to perform key distribution for symmetric ciphers (e.g., Diffie-Hellman).

AES is a widely used symmetric cipher that was established by the U.S. National Institute of Standards and Technology (NIST) in 2001. A challenge in designing a practical AES hardware device is to achieve an effective tradeoff between compactness and performance, where overall performance is affected by processing speed as well as other factors such as security. The security of an AES implementation (e.g., an AES hardware device) can include considerations such as immunity to side-channel attacks (SCAs) that seek to obtain the cipher key (e.g., the AES private key used between parties).

In some examples, to improve security and protect from attacks, masking operations may be utilized by or otherwise in combination with an AES cryptographic engine (e.g., an AES encryption engine, an AES decryption engine, or both). Masking is a countermeasure against side-channel attacks that involves randomizing the internal state of a cipher so that the observation of few intermediate values during encryption or decryption will not provide information about any of the sensitive variables such as the secret key. For instance, masking techniques can be used to protect AES against SCAs by masking some (or all) of the internal and/or intermediate values within an AES engine.

In some examples, masking in AES can be implemented based on a multiplicative inverse operation that utilizes an 8-bit random number generator along with additional circuitry such as dynamic look-up tables. Such techniques may require large amounts of entropy (e.g., wherein entropy is a measure of the quality and/or quantity of randomness) and may be complex and costly to implement. There is a need for systems and techniques that can be used to more efficiently implement masking for cryptographic ciphers and engines, including AES. For example, there is a need for systems and techniques that can be used to implement masking without using random bits and/or using a reduced quantity of random bits. There is also a need for systems and techniques that can be used to implement masking in parallel for several bits (e.g., rather than performing bit-wise masking for a single bit at a time). For example, there is a need for systems and techniques that can generate a plurality of multi-bit shares corresponding to a multi-bit input, where each multi-bit share of the plurality of multi-bit shares is based on or otherwise influenced by each bit of the multi-bit input. There is also a need for parallelism that can be used to simultaneously or concurrently generate the plurality of multi-bit shares corresponding to the multi-bit input.

Systems, apparatuses, processes (also referred to as methods), and computer-readable media (collectively referred to as “systems and techniques”) are described herein that can be used to perform deterministic masking for groups of multiple bits. In some aspects, a group of multiple bits can include a plurality of sensitive bits (e.g., bits included in a cryptographic key, internal data, intermediate cryptographic values, etc.). Masking can be performed in parallel for the multiple bits included in the group of bits. In some cases, the multiple bits are all sensitive bits to be protected, and masking can be performed without the use of random bits. In another example, masking can be performed for a group of multiple bits that includes at least one sensitive bit to be protected and at least one random bit.

In some examples, the deterministic masking described herein can be performed using a masking engine. The masking engine can be implemented in hardware and/or implemented in circuitry. In some cases, the masking engine can receive a multi-bit input and generate as output a plurality of shares corresponding to the multi-bit input. Each share can include multiple bits. In some cases, the shares can be combined to obtain the plaintext (e.g., un-masked) multi-bit input. For instance, the masking engine can generate shares that combine via an exclusive or (XOR) operation to reveal the un-masked multi-bit input.

In some aspects, the masking engine can receive a multi-bit input that includes at least two bits and can generate as output at least three shares corresponding to the multi-bit input. In one illustrative example, the masking engine can receive a four-bit input and generate as output four shares each having four bits (e.g., a total output of 16 bits). In some cases, the output bits of the masking engine can include one or more spare Hamming weight balancing bits (e.g., one or more parity bits, one or more adjustable additional data bits, etc.). As used herein, a spare Hamming weight balancing bit may also be referred to as a spare bit and/or an additional bit. In some cases, the one or more spare bits can be adjusted to implement parity bits. In one illustrative example, the one or more spare bits can be freely adjusted to ensure the property of each binary word (e.g., multi-bit output share) having a constant Hamming weight. For example, when the masking engine is used to generate four output shares each having four bits, the output can further include one spare Hamming weight balancing bit (e.g.) parity bit associated with each of the four-bit output shares, for a total of a 20-bit output (e.g., 4 output shares*(4 bits per share+1 spare Hamming weight balancing bit (e.g., parity bit) per share)=20 bits).

As will be described in greater depth below, the systems and techniques described herein can be used to implement masking in parallel for multiple bits. The systems and techniques can additionally avoid the use of external randomness in the masking operation, based on using deterministic randomness between the respective bits included in a multi-bit input to the masking engine or masking operation.

Additional aspects of the present disclosure are described with reference to the figures.

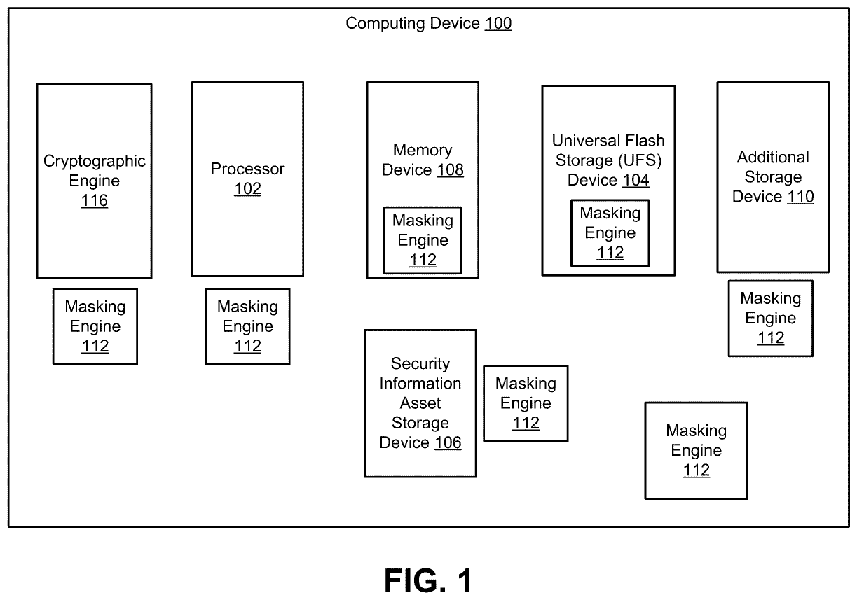

FIG. 1 is a block diagram illustrating an example of a computing device 100. As shown, the computing device 100 includes a processor 102, a universal flash storage (UFS) device 104, a security information asset storage device 106, a memory device 108, an additional storage device 110, a plurality of masking engines 112, and a cryptographic engine 116.

The computing device 100 is any device, portion of a device, or any set of devices capable of electronically processing instructions and may include, but is not limited to, any of the following: one or more processors (e.g., components that include integrated circuitry, memory, input and output device(s) (not shown), non-volatile storage hardware, one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality, virtual reality, etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

In some examples, the processor 102 is any component that includes circuitry for executing instructions (e.g., of a computer program). As an example, such circuitry may be integrated circuitry implemented, at least in part, using transistors implementing such components as arithmetic logic units, control units, logic gates, registers, first-in, first-out (FIFO) buffers, data and control buffers, etc. In some examples, the processor may include additional components, such as, for example, cache memory. In some examples, a processor retrieves and decodes instructions, which are then executed. Execution of instructions may include operating on data, which may include reading and/or writing data. In some examples, the instructions and data used by a processor are stored in the memory (e.g., memory device 108) of the computing device 100. A processor may perform various operations for executing software, such as operating systems, applications, etc. The processor 102 may cause data to be written from memory to storage of the computing device 100 and/or cause data to be read from storage via the memory. Examples of processors include, but are not limited to, central processing units (CPUs), graphics processing units (GPUs), neural processing units, tensor processing units, display processing units, digital signal processors (DSPs), finite state machines, etc. The processor 102 may be operatively connected to the memory device 108, any storage (e.g., UFS device 104, additional storage device 110, security information asset storage device 106, etc.) of the computing device 100. Processor 102 may additionally be connected to the masking engine 112, and/or to the cryptographic engine 116. In some examples, the processor 102 can include one or more masking engines 112 and/or can be associated with one or more masking engines 112. As illustrated in the example of FIG. 1, the processor 102 is associated with a corresponding instance of masking engine 112. The masking engine(s) 112 associated with the processor 102 can be uniquely associated with the processor 102 (e.g., are not shared across other components of the computing device 100). In some cases, the plurality of masking engines 112 can be separate instances or implementations of a masking engine, having same or similar architectures. Although FIG. 1 shows the computing device 100 having a single processor 102, the computing device may include any number of processors without departing from the scope of examples described herein.

In some examples, the computing device 100 includes a UFS device 104. In some examples, the UFS device 104 is a flash storage device conforming to the UFS specification. The UFS device 104 may be used for storing data of any type. Data may be written to and/or read from the UFS device 104. As an example, the UFS device may store operating system images, software images, application data, etc. The UFS device 104 may store any other type of data without departing from the scope of examples described herein. In some examples, the UFS device 104 includes NAND flash storage. The UFS device 104 may use any other type of storage technology without departing from the scope of examples described herein. In some examples, the UFS device 104 is capable of data rates that are relatively faster than other storage devices (e.g., additional storage device 110) of the computing device 100. The UFS device 104 may be operatively connected to the processor 102, the memory device 108, and/or the additional storage device 110. In some examples, the UFS device 104 may be operatively connected to the masking engine 112. In some aspects, the UFS device 104 can include one or more instances of the masking engine 112, as is illustrated in the example of FIG. 1. In some cases, the UFS device 104 can include one or more internally provided instances of masking engine 112 and can be associated with one or more externally provided instances of masking engine 112. Although FIG. 1 shows the computing device 100 having a single UFS device 104, the computing device may include any number of UFS devices without departing from the scope of examples described herein. Additionally, although FIG. 1 shows the UFS device 104, the computing device 100 may include any other type of flash storage device without departing from the scope of examples described herein.

In some examples, the computing device 100 includes an additional storage device 110. In some examples, the additional storage device is a non-volatile storage device. The additional storage device 110 may, for example, be a persistent memory device. In some examples, the additional storage device 110 may be computer storage of any type. Examples of type of computer storage include, but are not limited to, hard disk drives, solid state drives, flash storage, tape drives, removable disk drives, Universal Serial Bus (USB) storage devices, secure digital (SD) cards, optical storage devices, read-only memory devices, etc. Although FIG. 1 shows the additional storage device 110 as part of the computing device 100, the additional storage device may be separate from and operatively connected to the computing device 100 (e.g., an external drive array, cloud storage, etc.). In some examples, the additional storage device 110 operates at a data rate that is relatively slower than the UFS device 104. In some examples, the additional storage device 110 is also a UFS storage device. In some examples, the additional storage device 110 is operatively connected to the processor 102, the UFS device 104, the masking engine 112, the cryptographic engine 116, and/or the memory device 108. In some aspects, the additional storage device 110 can include one or more instances of the masking engine 112. In some examples, the additional storage device 110 can be associated with and/or can correspond to one or more instances of masking engine 112 provided external to additional storage device 110, as illustrated in the example of FIG. 1. In some cases, the additional storage device 110 can include one or more internally provided instances of masking engine 112 and can be associated with one or more externally provided instances of masking engine 112. Although FIG. 1 shows the computing device 100 having a single additional storage device 110, the computing device 100 may have any number of additional storage devices without departing from the scope of examples described herein.

In some examples, the computing device 100 includes a memory device 108. The memory device may be any type of computer memory. In some examples, the memory device 108 is a volatile storage device. As an example, the memory device 108 may be random access memory (RAM). In one or more examples, data stored in the memory device 108 is located at memory addresses, and is thus accessible to the processor 102, the masking engine 112, and/or the cryptographic engine 116 using the memory addresses. Similarly, the processor 102 and/or secure execution environment (or components therein) may write data to and/or read data from the memory device 108 using the memory addresses. The memory device 108 may be used to store any type of data, such as, for example, computer programs, the results of computations, etc. In some examples, the memory device 108 is operatively connected to the processor 102, the UFS device 104, the additional storage device 110, the masking engine 112, and/or the cryptographic engine 116. In some aspects, the memory device 108 can include one or more instances of the masking engine 112, as illustrated in the example of FIG. 1. In some examples, the memory device 108 can be associated with and/or can correspond to one or more instances of masking engine 112 provided external to memory device 108. In some cases, the memory device 108 can include one or more internally provided instances of masking engine 112 and can be associated with one or more externally provided instances of masking engine 112. Although FIG. 1 shows the computing device 100 having a single memory device 108, the computing device 100 may have any number of memory devices without departing from the scope of examples described herein.

In some examples, the computing device 100 includes the security information asset storage device 106. In some examples, the security information asset storage device 106 is any storage device configured to store security information assets (e.g., cryptographic keys, metadata, etc.). For instance, the security information asset storage device 106 is where security information assets are stored and initially obtained from when needed for use on a computing device (e.g., for encryption and/or decryption of data). In some cases, the security information asset storage device 106 can include a key store or a key table. Examples of a security information asset storage device include, but are not limited to, various types of read-only memory, one time programmable memory devices (e.g., one time programmable fuses or other types of one time programmable memory devices), non-volatile memory, etc. The security information asset storage device 106 may be operatively connected to the masking engine 112 and/or to the cryptographic engine 116. In some aspects, the security information asset storage device 106 can include one or more instances of the masking engine 112. In some examples, the security information asset storage device 106 can be associated with and/or can correspond to one or more instances of masking engine 112 provided external to security information asset storage device 106, as illustrated in the example of FIG. 1. In some cases, the security information asset storage device 106 can include one or more internally provided instances of masking engine 112 and can be associated with one or more externally provided instances of masking engine 112. Although FIG. 1 shows the computing device 100 as including a single security information asset storage device 106, the computing device 100 may include any number of security information asset storage devices without departing from the scope of embodiments described herein.

In some examples, the computing device 100 includes the cryptographic engine 116. In some cases, the cryptographic engine 116 can be an Advanced Encryption Standard (AES) engine. In some examples, the computing device 100 can include a plurality of cryptographic engines 116. For instance, computing device 100 can include a plurality of AES engines (e.g., also referred to as “AES workers”). In some examples, the cryptographic engine 116 is a hardware component (e.g., including circuitry) that may execute software and/or firmware, and is configured to perform various operations or services to secure the computing device 100. For instance, as described in more detail herein, the cryptographic engine 116 can perform an AES encryption and/or decryption using masked keys and/or masked data from the masking engine 112. In some aspects, the cryptographic engine 116 can include one or more instances of the masking engine 112. In some examples, the cryptographic engine 116 can be associated with and/or can correspond to one or more instances of masking engine 112 provided external to cryptographic engine 116, as illustrated in the example of FIG. 1. In some cases, the cryptographic engine 116 can include one or more internally provided instances of masking engine 112 and can be associated with one or more externally provided instances of masking engine 112.

In some examples, the computing device 100 includes a plurality of masking engines 112. In some aspects, the plurality of masking engines 112 can be instances of a same or similar masking engine. In some examples, the plurality of masking engines 112 can be hardware implementations of the same masking engine architecture. In some cases, the masking engine 112 can be used to perform masking for one or more bits. For example, masking engine 112 can be used to mask sensitive cryptographic keys (e.g., such as cryptographic keys stored in the security information asset storage device 106) and/or can be used to mask sensitive internal data (e.g., such as passwords, financial information, encrypted files, etc., stored in one or more of the memory device 108, UFS device 104, and/or additional storage device 110). In some examples, the computing device 100 can include a plurality of masking engines 112. In some cases, the computing device 100 can include a quantity of masking engines 112 that is greater than or equal to the quantity of cryptographic engines 116. For instance, one or more masking engines 112 can be provided for each AES worker of the cryptographic engine 116, etc. In some examples, the masking engine 112 is a hardware component (e.g., including circuitry) that may execute software and/or firmware, and is configured to perform various operations or services to secure the computing device 100 and cryptographic keys and/or internal data thereof.

In some examples, the computing device 100 includes any number of security components. The security components may be any component capable of performing various cryptographic services, and may thus be any hardware (e.g., circuitry), software, firmware, or any combination thereof. In some examples, the security components are a sub-chip hardware components of a system on a chip (SoC), which may include other components shown in FIG. 1 such as, for example, the processor 102, the masking engine 112, the cryptographic engine 116, and/or the security information asset storage device 106. Any other components of the computing device 100 may also be included as part of an SoC without departing from the scope of examples described herein. In some examples, the security components exist in a data path between storage devices (e.g., UFS storage device 104, additional storage device 110) and the memory device 108, and/or data paths between the processor 102 and the memory device 108 or any of the storage devices (e.g., 104, 110). In some examples, all or any portion of the security components may be considered “inline” cryptographic engines. In some examples, the security components are configured to perform any number of cryptographic service types on data being read from or written to a storage device (e.g., UFS device 104, additional storage device 110) and/or a memory device 108 of the computing device 100. In some examples, all or any portion of the data passing from memory to storage, from storage to memory, or to or from the processor 102 of the computing device 100 passes through a security component. In some aspects, the security components can include one or more additional masking engines, the same as or similar to the masking engine 112.

Examples of cryptographic service types that may be performed include, but are not limited to, encrypting data, decrypting data, key derivation, performing data integrity verification, and performing authenticated encryption and decryption. In some examples, the security components are configured to perform the various cryptographic service types by being configured to execute one or more cryptographic algorithms. As an example, to perform encryption and decryption, one or more security components may be configured to execute one or more of the Advanced Encryption Standard XOR-encrypt-XOR Tweakable Block Ciphertext Stealing (AES-XTS) algorithm, the AES-Cypher Block Chaining (AES-CBC) algorithm, the AES-Electronic Codebook (AES-EBC) algorithm, the Encrypted Salt-Sector Initialization Vector-AES-CBC (ESSIV-AES-CBC) algorithm, etc., including any variants of such algorithms (e.g., 128 bits, 192 bits, 256 bits, etc.). As another example, to perform integrity verification, the security component may be configured to execute a hash algorithm such as, for example, the one or more members of the SHA family of hash algorithms. As another example, to perform authenticated encryption, a security component may be configured to perform the AES-Galois/Counter Mode (GCM) algorithm. The security component may be configured to execute any other cryptographic algorithms without departing from the scope of examples described herein.

While FIG. 1 shows a certain number of components in a particular configuration, one of ordinary skill in the art will appreciate that the computing device 100 may include more components or fewer components, and/or components arranged in any number of alternate configurations without departing from the scope of examples described herein. Additionally, although not shown in FIG. 1, one of ordinary skill in the art will appreciate that the computing device 100 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 1. The components shown in FIG. 1 may or may not be discrete components. In some aspects, one or more of the components can be combined into different hardware elements, implemented in software, and/or otherwise implemented using software and/or hardware. As used herein, the term device may be a discrete component or apparatus, or may not be a discrete component. In some aspects, other devices can exist within, be part of, and/or utilize the same hardware components as a device.

As noted previously, systems and techniques are described herein that can be used to perform deterministic masking for multiple bits. Masking can be performed in parallel for the multiple bits included in the group of bits. In some cases, the multiple bits are all sensitive bits to be protected, and masking can be performed without the use of random bits. In another example, masking can be performed for a group of multiple bits that includes at least one sensitive bit to be protected and at least one random bit. In some cases, the systems and techniques can be used to perform deterministic local key masking for high-speed encryption with key reuse, as will be described in greater depth below.

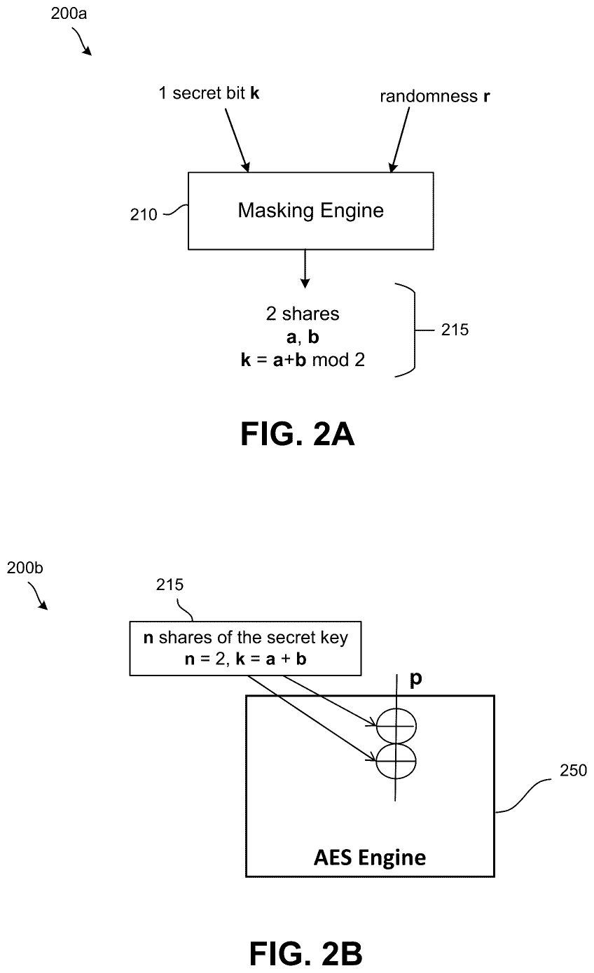

FIG. 2A is a diagram illustrating an example of single-bit masking 200a that can be performed using two shares, in accordance with some examples. A masking engine 210 can receive as input a secret bit k and a random bit r. The secret bit k can be a single bit obtained from sensitive data that is to be protected (e.g., masked) using masking engine 210. For instance, the secret bit k can be obtained from a larger (e.g., multi-bit) secret key or other data. The secret bit k can be provided to masking engine 210 as plaintext.

The random bit r can be obtained or otherwise generated based on one or more sources of randomness that are available to or associated with the masking engine 210. For example, the random bit r can be obtained from or generated based on an external source of randomness (e.g., a source of randomness not included in the masking engine 210). In one illustrative example, the random bit r can be obtained using an external source of randomness such as a random number generator (e.g., implemented in software or hardware, separate from the masking engine 210). For instance, when the masking engine 210 is used to perform masking for AES (e.g., when the two shares 215 output by masking engine 210 are provided as input to an AES engine or AES worker), the random bit r can be obtained using an 8-bit random number generator and/or dynamic look-up tables, as mentioned previously.

In one illustrative example, masking engine 210 can perform masking by replacing the one bit of secret key (e.g., k) with n=2 (or more) bits. These replacement bits are also referred to as “shares” or “shares.” For instance, masking engine 210 can generate two shares 215, as depicted in FIG. 2A. The shares 215 can include a first share, a, and a second share, b, that are generated by the masking engine 210 such that the sum modulo 2 of the shares 215 is equal to the original (e.g., unmasked) value of the one bit secret key k. For example, masking engine 210 can generate the shares a and b such that k=(a+b) mod 2. It is noted that the modulo 2 addition of bits is the same as the exclusive or (XOR) of the bits. For example, (1+1)mod 2=2 mod 2=0, and 1 XOR 1=0; (1+0)mod 2=1 mod 2=1, and 1 XOR 0=1.

To generate the shares a, b such that their XOR is equal to the unmasked value of the secret key k, the masking engine 210 can use the random bit r. For example, given the random bit r (e.g., having a random value of either 0 or 1), the masking engine 210 can generate the first share a=k and can generate the second share b=r XOR k. In this example, if r=1 and k=1, the masking engine 210 can generate a=1 and b=1 XOR 1=0. These values of a and b meet the masking condition, such that a XOR b=k (e.g., 1 XOR 0=1=k).

Various other implementations can be used by masking engine 210 to protect the secret key k using an input of randomness (e.g., using one or more random bits r). To mask multiple bits or multi-bit sequences, such as AES encryption keys, the masking engine 210 can repeatedly perform the single-bit masking of FIG. 2A. For example, masking engine 210 can perform masking for a 128-bit AES encryption key by performing single-bit masking for each of the 128 bits included in the 128-bit AES encryption key. In another example, 128 instances of the masking engine 210 can each perform single-bit masking for a different one of the 128 bits included in the 128-bit AES encryption key. Larger multi-bit sequences can be masked in a shorter amount of time by using multiple instances of the single-bit masking engine 210 operating in parallel on different bits included in the multi-bit sequence.

Masking, such as the bit-level masking performed by masking engine 210, can be used to protect secret information based on generating two or more shares 215 that individually do not convey information indicative of the secret key k. In some aspects, masking engine 210 can be included within a secure perimeter or secure enclave (e.g., trusted execution zone or trusted execution environment) of an SoC or electronic device implementing masking. For example, masking engine can be used to perform masking within a secure perimeter, before any routine encryption based on the secret key k. In some cases, security can be improved by subsequently manipulating only the shares a, b corresponding to the unmasked secret k.

FIG. 2B is a diagram 200b illustrating an example of an AES engine 250 that can receive as input shares 215 corresponding to a secret key k. In one illustrative example, the shares a,b provided as input to AES engine 250 in FIG. 2B can be the same as the shares a,b generated as output for the secret key k using the masking engine 210 of FIG. 2A. In the example of FIG. 2B, the AES engine 250 can be configured to receive two shares corresponding to a masked secret key, although it is noted that AES engine 250 may be configured to receive a greater quantity of shares corresponding to a masked secret key.

The AES engine 250 (also referred to as an AES worker) can use the shares 215 of the secret key k to compute a final masked result without unmasking any of the intermediate values. The diagram 200b of FIG. 2B illustrates the first step of an example operation of AES engine 250. In this example, AES engine 250 can use the shares 215 of the secret key k to encrypt a plaintext sequence p, wherein AES engine 250 performs the encryption without unmasking the plaintext value of the secret key k. For instance, AES engine 250 can encrypt the plaintext p by determining the XOR between each bit of p and the two shares 215. For example, a first plaintext bit p₁ can be encrypted based on determining p₁ XOR a XOR b; a second plaintext bit p₂ can be encrypted based on determining p₂ XOR a XOR b; etc. The XOR operation is commutative and associative, so the XOR between the plaintext bits p and the two shares a,b can be performed in any order (e.g., p XOR a XOR b=p XOR b XOR a).

In some cases, the AES engine 250 can be the same as or similar to the cryptographic engine 116 of FIG. 1 and/or the masking engine 210 can be the same as or similar to the masking engine 112 of FIG. 1. In some aspects, the masking engine 210 (and/or various other masking operations) can be implemented external to the AES engine 250, such that the unmasked secret key k is not inadvertently exposed or leaked to the AES engine 250.

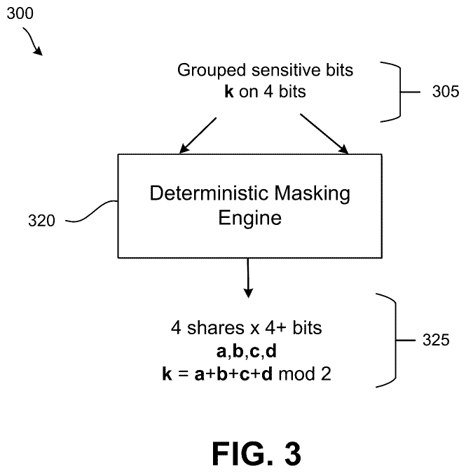

FIG. 3 is a diagram 300 illustrating an example of a deterministic masking engine 320, in accordance with aspects of the present disclosure. In one illustrative example, the deterministic masking engine 320 can be used to perform deterministic masking for groups of multiple bits. For instance, the deterministic masking engine 320 can perform masking for a multi-bit input 305 (e.g., grouped sensitive bits). In some examples, the multi-bit input 305 (e.g., the grouped sensitive bits) can represent a secret key k on at least two bits (e.g., the secret key k provided as input to deterministic masking engine 320 includes at least two bits). In one illustrative example, the multi-bit input 305 (e.g., the grouped sensitive bits) can represent a secret key k on four or more bits (e.g., the secret key k includes four or more bits).

It is noted that the “secret key” k can include various different types of sensitive bits (e.g., bits for which masking protection is to be performed). For instance, in some cases the multi-bit secret key k can include multiple bits of a secret cryptographic key, such as an AES private key. In another example, the multi-bit secret key k can include multiple bits of internal data and/or intermediate values (e.g., associated with an SoC or device implementing the deterministic masking engine 320, such as a device having the computing device architecture of the computing device 100 of FIG. 1).

The deterministic masking engine 320 can perform deterministic masking without using random bits (e.g., such as the random bit r of FIG. 2A) and/or can perform deterministic masking using a reduced quantity of input random bits. In one illustrative example, deterministic masking engine 320 can perform masking in parallel for the multiple bits included in the grouped sensitive bits 305 (e.g., the multi-bit secret key k). In some cases, the multiple bits are all sensitive bits to be protected, and masking can be performed without the use of random bits. For instance, when deterministic masking engine 320 utilizes a 4-bit grouped input k, all four bits of k can correspond to sensitive information from a cryptographic key or internal data. In another example, masking can be performed for a multi-bit grouped input k that includes at least one sensitive bit to be protected and at least one random bit. For example, the 4-bit grouped input k could include 3 bits of sensitive information and 1 random bit; could include 2 bits of sensitive information and 2 random bits; could include 1 bit of sensitive information and 3 random bits; etc. It is also noted that the example of k=4 bits is provided for purposes of example, and it is contemplated that the deterministic masking engine 320 can also be used to implement multi-bit masking for k>4 input bits. The deterministic masking engine 320 can be implemented in hardware and/or implemented in circuitry. In some examples, the deterministic masking engine 320 can be the same as or similar to the masking engine 112 of FIG. 1 or can be otherwise included in the architecture of the computing device 100 of FIG. 1.

As illustrated, the deterministic masking engine 320 can receive the multi-bit input 305 and generate as output a plurality of multi-bit shares 325 corresponding to the multi-bit input 305. For example, deterministic masking engine 320 can receive the four-bit secret k and can generate as output four shares a, b, c, d that correspond to the multi-bit secret k. The quantity of shares, n, generated as output by deterministic masking engine 320 can be the same as the number of bits in k or can be different than the number of bits in k. In one illustrative example, the deterministic masking engine 320 receives as input a multi-bit secret k having at least two bits, and generates as output at least three shares.

In the example of FIG. 3, k=4 bits and n=4 shares. The deterministic masking engine 320 generates the output shares a, b, c, d such that k=(a+b+c+d)mod 2. Because modulo 2 addition of bits is the same as the XOR of the bits, the expression above can also be given as k=a XOR b XOR c XOR d. The output shares a, b, c, d can later be combined (e.g., by an AES engine, cryptographic engine, etc.) to recover the plaintext of the multi-bit secret k provided as input to the deterministic masking engine 320.

Each of the output shares 325 generated by the deterministic masking engine 320 can include multiple bits. For example, each of the output shares a, b, c, d can include four-bits, such that deterministic masking engine generates a 16-bit output for the 4-bit secret k received as input. In some cases, each respective output share of the output shares 325 can include one or more spare Hamming weight balancing bits (e.g., parity bits). For example, deterministic masking engine 320 can generate each of the output shares a, b, c, and d to further include at least one spare Hamming weight balancing bit (e.g., parity bit). For instance, when each of the four output shares a, b, c, d includes a single spare Hamming weight balancing bit (e.g., parity bit), deterministic masking engine 320 generates a 20-bit output (e.g., 4 output shares*(4 bits per share+1 spare Hamming weight balancing bit (e.g., parity bit) per share)=20 bits). In some examples, each of the four output shares 325 can include a quantity of bits that is greater than or equal to the quantity of bits k of the multi-bit input 305. For instance, the output shares 325 can include four shares each generated on 4 bits. In another example, the output shares 325 can include four shares each generated on 5 bits (e.g., 4 bits representing a particular share and 1 bit representing a parity bit for the particular share). In some examples, each output share of the output shares 325 can include 6 or more bits. In some aspects, increasing the quantity of bits per output share 325 can increase a signal-to-noise ratio (SNR) associated with the output shares 325 and/or can make it more challenging for an attacker to track or distinguish between the individual bits.

In some aspects, the deterministic masking engine 320 can mask a given one of the bits included in the multi-bit secret k using deterministic randomness obtained from the remaining bits in the multi-bit secret k. For example, deterministic randomness can be obtained from the value of the multi-bit secret k itself. When the multi-bit secret k is a cryptographic key (or obtained as a portion of a cryptographic key), inherent randomness can be present between the different bit values of the key (e.g., entropy can be obtained to mask a particular bit in k from the remaining k−1 bits).

In one illustrative example, the deterministic masking engine 320 generates the output shares 325 to have a constant Hamming weight. In some aspects, the constant Hamming weight of one or more output shares can be associated with a constant toggle count of the one or more output shares (e.g., in subsequent use(s) and/or application(s) of the output shares 325. In some aspects, the toggle count for the output shares 325 can be the same as the Hamming weight of the output shares 325 (e.g., the quantity of bits having a value of ‘1’ in a binary word (e.g., base 2 representation) associated with each respective share of the output shares 325)). In some examples, the constant toggle count (e.g., Hamming weight) of the output shares 325 can be equal to two. For instance, with a constant toggle weight of two, the XOR between the four output shares a, b, c, d and any quantity (e.g., either ‘0’ or ‘1’) will result in the same number of bit flips between 0 and 1 (e.g., a total of two flips, or “toggles”), based on each of the four output shares a, b, c, d each having two 1s in their corresponding binary word or base2 representation.

In some aspects, the deterministic masking engine 320 can generate the output shares 325 such that each of the 16 output bits included in the four output shares a, b, c, d is decorrelated from any of the input bits of the multi-bit secret k and is decorrelated from any pair of input bits of the multi-bit secret k. In examples in which deterministic masking engine 320 generates a spare Hamming weight balancing bit (e.g., parity bit) for each of the four output shares a, b, c, d (e.g., for a total of 20 output bits), each of the 20 output bits can be decorrelated from any of the input bits and pairs of input bits in the multi-bit secret k.

As mentioned previously, the deterministic masking engine 320 can jointly protect the individual bits of the multi-bit secret k based on masking the individual bits in parallel. For example, the deterministic masking engine 320 can receive each respective bit included in the input multi-bit secret k simultaneously, and can generate a respective masking result (e.g., output share) for each of the multiple bits in parallel.

In some examples, multiple deterministic masking engines 320 can be used to perform masking for bit sequences that are longer (e.g., include a greater quantity of bits) than the input bit quantity associated with each deterministic masking engine 320. For instance, a 128-bit AES private key can be masked using 32 deterministic masking engines 320 that each generate a corresponding set of output shares a, b, c, d for a different 4-bit secret k included in the 128-bit AES private key (e.g., 4*32=128 bits).

In some examples, deterministic masking engine 320 can implement more secure masking by including one or more random bits in the multi-bit secret k utilized as input. For example, each deterministic masking engine 320 can perform masking for a multi-bit secret input k comprising two key bits and two random bits (e.g., in which case a 128-bit AES private key can be masked using 64 deterministic masking engines 320, 2*64=128 bits).

Table 1, below, provides an example implementation of deterministic masking engine 320 for a 4-bit secret input k.

TABLE 1
Example implementation of deterministic masking for a k = 4 multi-bit input using n = 4 shares (a,
b, c, d). Here, k represents the 16 possible 4-bit input sequences; kₚ adds a fifth spare Hamming weight
balancing bit (e.g., parity bit) to each share in the leading (e.g., first) bit position. Each of the n = 4 shares
(a, b, c, d) is provided as a 4-bit value, with a fifth spare Hamming weight balancing bit (e.g., parity bit) in
the leading (e.g., first) bit position.

| | | | | | | | | | | | | | | | | |
|---|---|---|---|---|---|---|---|---|---|---|---|---|---|---|---|---|
| a | 10100 | 00110 | 01100 | 01100 | 11000 | 01010 | 10010 | 10010 | 01010 | 11000 | 10010 | 10010 | 00110 | 10100 | 01100 | 01100 |
| b | 11000 | 00101 | 11000 | 00101 | 10100 | 11000 | 00101 | 01001 | 00101 | 11000 | 00101 | 11000 | 01001 | 00101 | 11000 | 10100 |
| c | 01010 | 00011 | 10010 | 01001 | 01001 | 10001 | 10010 | 11000 | 10001 | 11000 | 01001 | 10010 | 10010 | 01010 | 01001 | 00011 |
| d | 00110 | 10001 | 10100 | 00011 | 10001 | 00110 | 00011 | 10100 | 00110 | 10001 | 10100 | 00011 | 10001 | 00110 | 00011 | 10100 |
| kₚ | 00000 | 10001 | 10010 | 00011 | 10100 | 00101 | 00110 | 10111 | 11000 | 01001 | 01010 | 11011 | 01100 | 11101 | 11110 | 01111 |
| k | 0000 | 0001 | 0010 | 0011 | 0100 | 0101 | 0110 | 0111 | 1000 | 1001 | 1010 | 1011 | 1100 | 1101 | 1110 | 1111 |

In the example implementation of deterministic masking depicted in Table 1, the deterministic masking is performed for a k=4 multi-bit input using n=4 shares (a, b, c, d). Here, k represents the 16 possible 4-bit input sequences; kₚ adds a fifth spare Hamming weight balancing bit (e.g., parity bit) to each share in the leading (e.g., first) bit position. Each of the n=4 shares (a, b, c, d) is provided as a 4-bit value, with a fifth spare Hamming weight balancing bit (e.g., parity bit) in the leading (e.g., first) bit position.

In some aspects, deterministic masking engine 320 can perform deterministic masking based on implementing Table 1 as a look-up table (LUT). In other examples, deterministic masking engine 320 can be implemented in circuitry, with the share values of Table 1 (e.g., the 16 different share values for a, b, c, d corresponding to the 16 different 4-bit input sequences that are possible for k) encoded in the circuitry used to implement deterministic masking engine 320.

In one illustrative example, deterministic masking engine 320 can be implemented in circuitry for k−4, n=4 with 4-bit shares using a total of 23 gates and 20 XORs, as follows:

bool q_00 = XOR(x_000, x_002);
bool q_01 = NOR(x_001, q_00);
bool q_02 = XOR(q_00, x_001);
bool q_03 = NAND(q_02, x_002);
bool q_04 = XOR(q_00, x_003);
bool q_05 = NOR(q_00, q_01);
bool q_06 = XOR(q_03, q_04);
bool q_07 = XOR(x_002, q_06);
bool q_08 = XOR(x_003, x_002);
bool q_09 = XOR(q_02, q_08);
bool d0 = q_00; bool d1 = q_02 XOR 1; bool d2 = q_00 XOR 1;
bool d3 = 0; bool d4 = q_02; bool c0 = 1 XOR q_07; bool c1 =
q_09 XOR q_01; bool c2 = 0; bool c3 = q_09 XOR 1; bool
c4 = q_07 XOR q_01; bool b0 = q_06 XOR 1; bool b1 = 0;
bool b2 = q_03 XOR q_06; bool b3 = 1 XOR q_04; bool b4 =
q_06; bool a0 = 0; bool al = q_05 XOR q_09; bool a2 = q_08
XOR 1; bool a3 = q_09 XOR q_00; bool a4 = q_08 XOR q_01;
23 gates total

In some aspects, the systems and techniques can be used to implement masking using a deterministic, universal, and re-usable data and/or key protection unit (e.g., deterministic masking engine 320) configured to amplify entropy obtained from local sources in order to avoid the need for external randomness (e.g., such as the random bit r of FIG. 2A), as has been described above.

The deterministic masking engine 320 can be utilized to protect (e.g., using masking) key bits and/or data bits at various locations within an SoC or computing device implementing one of the deterministic masking engines 320 (e.g., such as a computing device implementing architecture 100 of FIG. 1). For example, an SoC may include a plurality of AES engines and/or various other cryptographic engines. The respective AES engines included in the plurality of AES engines in the SoC may run in various AES modes. The respective AES engines included in the plurality of AES engines in the SEC may additionally run in parallel, at varying and/or increasing speeds.

In some cases, sensitive bits (e.g., key bits, data bits, intermediate bits, internal bits, etc.) may not be well protected at the boundaries of the AES engines running in an SoC. For example, sensitive bits may be transmitted outside of the AES engines of the SoC in plaintext, with weak security, or various combinations of the two. The systems and techniques described herein can be used to provide deterministic masking at the boundaries of some (or all) of the plurality of AES engines running in an SoC. The systems and techniques described herein can also be used to provide improved security for secret key reuse associated with the AES engines and/or other cryptographic engines running in an SoC.

In one illustrative example, the systems and techniques described herein can use a deterministic masking engine (e.g., such as the deterministic masking engine 320) to generate a plurality of multi-bit shares corresponding to (e.g., jointly representative of) a multi-bit input. IN some aspects, the plurality of multi-bit shares are jointly generated using the multi-bit input, wherein each particular share of the plurality of multi-bit shares is influenced by all of the respective bits included in the multi-bit input. For instance, a four-bit input can be used by deterministic masking engine 320 to generate four multi-bit shares each having four bits (e.g., a total of 16 bits). A first four-bit share generated by deterministic masking engine 320 can be generated based on, or otherwise influenced by, all four of the bits included in the four-bit input; a second four-bit share generated by deterministic masking engine 320 can be generated based on, or otherwise influenced by, all four of the bits included in the four-bit input; a third four-bit share generated by deterministic masking engine 320 can be generated based on, or otherwise influenced by, all four of the bits included in the four-bit input; and a fourth four-bit share generated by deterministic masking engine 320 can be generated based on, or otherwise influenced by, all four of the bits included in the four-bit input.

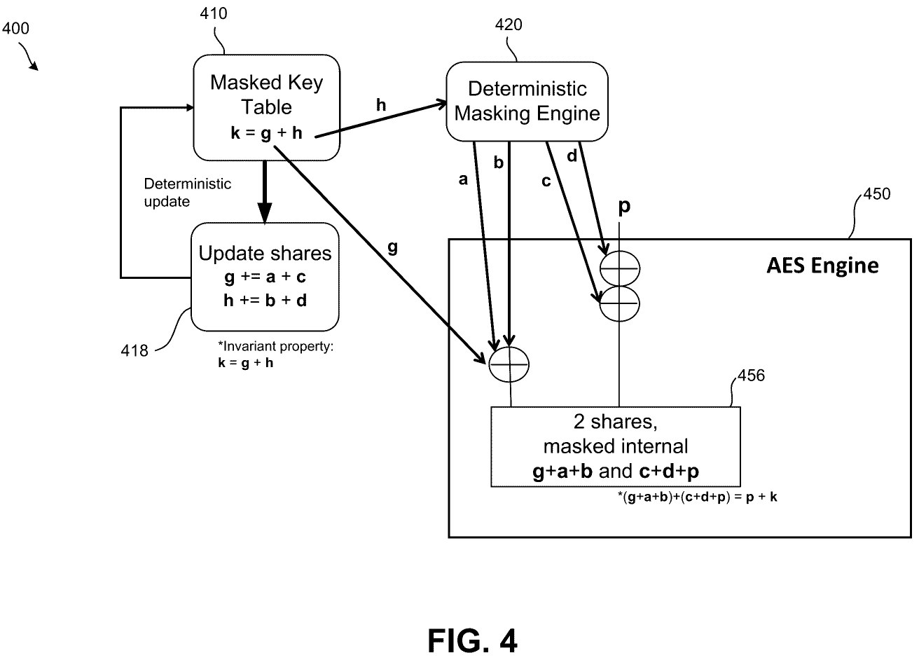

In some examples, the systems and techniques can transmit the plurality of shares generated by the deterministic masking engine (e.g., deterministic masking engine 320 of FIG. 3, deterministic masking engine 420 of FIG. 4) to a cryptographic engine. For example, the cryptographic engine can be an AES engine. The plurality of shares can be transmitted using an exclusive hardware wired connection. For instance, an exclusive hardware wired connection between the deterministic masking engine and the cryptographic engine can be used to transmit (from the deterministic masking engine to the cryptographic engine) a plurality of multi-bit shares indicative of an input value being masked and protected by the deterministic masking engine. The exclusive hardware wired connection can be a hardware wired connection (e.g., a wired, a printed circuit board (PCB) trace, etc.) between the deterministic masking engine and the cryptographic engine that is only used for communications and/or signal transmission between the deterministic masking engine and the cryptographic engine. In some aspects, the deterministic masking engine can be included in the cryptographic engine, and the exclusive hardware wired connection can be an internal connection of the cryptographic engine. In some examples, the deterministic masking engine can be external to the cryptographic engine, and the exclusive hardware wired connection can be an external connection of both the cryptographic engine and the deterministic masking engine.

For instance, the deterministic masking described herein can be used to enhance the security of both protected AES implementations and unprotected AES implementations. A protected AES implementation can include protected AES GMAC (e.g., an AES engine implementing Galois/Counter Mode (GCM) and/or using a Galois Message Authentication Code (GMAC)). In some aspects, one or more deterministic masking engines (e.g., such as deterministic masking engine 320) can be utilized to mask secret values k by providing the protected AES engines with deterministically generated shares corresponding to the secret value k. An unprotected AES implementation does not implement other bit security protection techniques. For example, unprotected AES implementations can include unprotected UFS ICE encryption for mobile operating systems (e.g., unprotected UFS, flash volume, or other storage volume encryption), in which case the systems and techniques can be used to protect the UFS ICE encryption using one or more deterministic masking engines 320. Unprotected AES implementations can additionally include unprotected secure zones or secure enclaves running in an SoC and/or mobile computing device (e.g., such as a mobile computing device implementing the architecture 100 of FIG. 1). Unprotected secure zones or enclaves can be protected using one or more of the deterministic masking engines 320 to deterministically mask sensitive key bits and/or sensitive data bits crossing the boundary of the otherwise unprotected secure zone or enclave.

In one illustrative example, the systems and techniques can be used to provide deterministic masking of sensitive data bits and/or sensitive key bits using variable strength protection. For instance, variable strength protection can be implemented using different protection levels associated with the deterministic masking engine 320. For example, a highest protection level (referred to herein as ‘Protection level 4’) can be associated with utilizing randomness inside of an AES engine (e.g., deterministic masking engine 320 is implemented within the AES engine and utilizes one or more random bits r in the multi-bit input k to mask internal and intermediate values within the AES engine)

A ‘Protection level 3’ can be associated with utilizing randomness at the boundaries of an AES engine (e.g., deterministic masking engine 320 is implemented at the boundaries of the AES engine and utilizes one or more random bits r in the multi-bit input k to mask sensitive information transmitted to and/or from the AES engine).

A ‘Protection level 2’ can be associated with utilizing randomness at key scheduling only. For instance, key scheduling can be performed using a key scheduler engine or key scheduler device. The key scheduler can be run prior to or parallel to encryption, and used to generate masked keys (e.g., used to generate multiple shares corresponding to each plaintext key in a key table). In this example, one or more of the deterministic masking engines 320 can be used to generate the shares from the plaintext key values (e.g., bits) stored in the key table. At protection level 2, the one or more deterministic masking engines 320 can utilize one or more random bits r and one or more plaintext key bits in the multi-bit input k that is masked.

A ‘Protection level 1’ can be associated with utilizing randomness at the key table (KT) only, at a secure enclave only, or both. For example, the deterministic masking engine 320 can be used during key generation performed to populate the key table, wherein the deterministic masking engine 320 utilizes one or more random bits r in the multi-bit input k used in generating one or more keys for populating the key table. In another example, the deterministic masking engine 320 can be used to secure (e.g., mask) intermediate or internal values within the boundaries of the secure enclave, based on implementing the deterministic masking engine 320 within the boundaries of the secure enclave. In another example, the deterministic masking engine 320 can be used to secure (e.g., mask) sensitive data and/or key bits that are transmitted to or from the secure enclave, based on implementing the deterministic masking engine 320 at or outside the boundaries of the secure enclave.

A ‘Protection level 0’ can be associated with utilizing deterministic randomness (e.g., the multi-bit secret input k to deterministic masking engine 320 does not include any random bits r and includes only sensitive data bits) at a secure enclave key table or HWKM slave level only.

In some aspects, the protection levels described above can be additive or cumulative. For instance, implementing Protection level 4 can include implementing some (or all) of the lower Protection levels 0-3; implementing Protection level 3 can include implementing some (or all) of the lower Protection levels 0-2; etc. In one illustrative example, the systems and techniques described herein can obtain randomness based on a combination of local entropy sources (e.g., based on a combination of local entropy sources at each of the deterministic masking engines 320 used to implement the various additive/cumulative Protection levels).

As mentioned previously, in some examples the systems and techniques can be used to provide deterministic masking of key bits and/or data bits provided to a plurality of AES engines in an SoC. For example, the deterministic masking engine 320 can be used to generate shares corresponding to multi-bit portions of an AES private key, wherein the shares from the deterministic masking engine 320 are used to securely transmit the AES private key to the plurality of AES engines in the SoC. FIG. 4 is a diagram 400 illustrating an example of a deterministic masking engine used to implement a deterministic update for shares utilized by an AES engine, in accordance with aspects of the present disclosure.

As illustrated in FIG. 4, a deterministic masking engine 420 can be provided at the boundary (e.g., external to) an AES engine 450. In some examples, the deterministic masking engine 420 of FIG. 4 can be the same as or similar to the deterministic masking engine 320 of FIG. 3. In some cases, the AES engine 450 can be the same as or similar to the AES engine 250 of FIG. 2B.

The deterministic masking engine 420 can be used to protect AES private key information that is transmitted between a key store and the AES engine 450. In some aspects, and as illustrated in FIG. 4, the key store can be a masked key table 410. The masked key table 410 can include one or more keys (e.g., AES private keys, among various others) that have already undergone at least a first level of protection. For instance, masked key table 410 can include a plurality of pairs of shares g, h that each represent a respective plaintext key k (or portion thereof). For instance, each entry in masked key table 410 can include a first multi-bit share h and a second multi-bit share g, where k=g XOR h. In one illustrative example, the masked key table 410 can include a plurality of shares (e.g., g, h, etc.) that are each multi-bit shares generated using a masking engine. In some aspects, the input share h provided to the deterministic masking engine 420 can be a multi-bit input comprising a multi-bit share associated with a cryptographic key of masked key table 410. As noted above, the first multi-bit share h can be included in a pair of multi-bit shares g, h that jointly represent a plaintext key k based on an XOR between the pair of multi-bit shares. The second multi-bit share g can be provided to AES engine 450, as will be described in greater depth below.

In some examples, the multi-bit shares g, h can be generated using the masking engine 210 of FIG. 2A (e.g., where the multi-bit shares a, b of FIG. 2A are the same as or similar to the multi-bit shares g, h of FIG. 4). In another example, the multi-bit shares of masked key table 410 can be generated using the deterministic masking engine 320 of FIG. 3. For instance, the second multi-bit share g can be equal to the XOR of the shares a, b generated by the deterministic masking engine 320 of FIG. 3 and the first multi-bit share h can be equal to the XOR of the shares c, d generated by the deterministic masking engine 320 of FIG. 3, etc.

The multi-bit shares g, h can be secured when transmitted between masked key table 410 and AES engine 450 based on additional masking (e.g., deterministic masking) performed by the deterministic masking engine 420. For example, one of the two multi-bit shares (e.g., the second multi-bit share, g) can be provided directly to AES engine 450 and the other one of the two multi-bit shares (e.g., the first multi-bit share, h) can be provided as input to the deterministic masking engine 420. The second multi-bit share g can be provided to AES engine 450 in plaintext (e.g., the plaintext bit values of the second multi-bit share g are provided, without further protection).

The first multi-bit share h can itself be deterministically masked by deterministic masking engine 420, based on providing the first multi-bit share h to the deterministic masking engine 420 as a multi-bit input for masking. Based on the first multi-bit share h, the deterministic masking engine 420 generates as output the four shares a, b, c, d such that h=(a+b+c+d)mod 2=a XOR b XOR c XOR d (e.g., in a manner the same as or similar to that described above with respect to the four shares a, b, c, d generated as output by deterministic masking engine 320 of FIG. 3 for the input k). In one illustrative example, the four shares a, b, c, d jointly represent the first multi-bit share h associated with the cryptographic key k, based on an XOR between each respective share of the at least four shares a, b, c, d. In some aspects, the four shares a, b, c, d can be multi-bit shares. For example, each of the four shares a, b, c, d can be multi-bit shares having a same quantity of bits as the first multi-bit share h (e.g., each share may have four bits).

The four shares a, b, c, d generated by deterministic masking engine 420 mask the plaintext value of the bits of the first multi-bit share h, such that providing the four shares a, b, c, d in plaintext to AES engine 450 does not reveal the underlying (e.g., un-masked) value of h. The four shares a, b, c, d allow the first multi-bit share h to be protected when it is provided to AES engine 450, because the un-masked value of h can only be recovered by capturing each of the four shares a, b, c, d and calculating their XOR.

The AES engine can encrypt a plaintext input, p, with the AES key k from masked key table 410 without unmasking the plaintext value of k. For instance, the AES engine 450 can receive inputs comprising the plaintext of the second multi-bit share g (e.g., directly from masked key table 410), and the four shares a, b, c, d generated by deterministic masking engine 420 to further mask the first multi-bit share h. In some examples, an additional deterministic masking engine (e.g., a separate instance or hardware implementation of the deterministic masking engine 420) can be used to mask the second multi-bit share g based on generating an additional at least four shares that jointly represent g based on their XOR. For instance, the deterministic masking engine 420 can be a first masking engine used to mask the first multi-bit share h by generating the at least four shares a, b, c, d that are jointly representative of h. A second masking engine (e.g., the same as or similar to deterministic masking engine 420) can be used to mask the second multi-bit share g by generating an additional at least four shares a′, b′, c′, d′ that are jointly representative of g based on the XOR of the additional at least four shares.

Based on these five inputs, the AES engine 450 can generate two internal shares 456 that can be used to encrypt (e.g., mask) the plaintext input p using the symmetric key k. In this example, the internal shares 456 can be determined and/or utilized within the AES engine 450 (e.g., are internal to the AES engine 450). The first internal share can be generated using the multi-bit share g, and one or more of the four shares a, b, c, d generated by deterministic masking engine 420 to be jointly representative of the multi-bit share h. In one illustrative example, the first internal share of AES engine 450 can be generated as the XOR between g, a, and b (e.g., g XOR a XOR b=(g+a+b)mod 2).

The second internal share can be generated using the plaintext input p and the remaining ones of the four shares a, b, c, d that are not used by AES engine 450 to generate the first internal share. For instance, the second internal share of AES engine 450 can be generated as the XOR between p, c, and d (e.g., p XOR c XOR d=(p+c+d)mod 2).

The AES engine 450 can use the two internal shares to encrypt the plaintext input p with the symmetric key k. For example, the XOR between the first internal share and the second internal share can be equal to the XOR between the plaintext input p and the symmetric key k, even though the plaintext value of symmetric key k is not revealed or directly calculated. For instance, (g XOR a XOR b) XOR (p XOR c XOR d)=p XOR k, and p XOR k is the operation used to encrypt the plaintext input k using the symmetric key k.

In one illustrative example, a deterministic update 418 can be performed every time the AES engine 450 reads a particular key k from the masked key table. For instance, in encryption with key reuse, the AES engine 450 may read or otherwise utilize the same key k multiple times. The first or initial time that AES engine 450 reads the key k from masked key table 410 can be performed as described above. Subsequently, deterministic update 418 can be performed to update the shares g and h corresponding to the key k. In one illustrative example, the updated shares can be determined as g+=a+c and h+=b+d. wherein the ‘+’ operator here represents an XOR (e.g., g₂=g₁ XOR a XOR c and h₂=h₁ XOR b XOR d).

The deterministic update 418 can be implemented to be invariant, such that the relationship k=g XOR h always holds, independent of how many times deterministic update 418 is performed for a particular key k. Based on the invariant property of deterministic update 418, each time that AES engine 450 needs to read the key k from masked key table 410, a different set of inputs (e.g., the five shares g, a, b, c, d) are provided to the AES engine 450, but can be combined internally within AES engine 450 in the same way to always be able to encrypt the plaintext input p with the key k.

In one illustrative example, the approach of FIG. 4 can be seen to push the use of randomness to the first stage of the cryptographic key encryption/decryption process. For example, randomness can be used to generate either the individual keys of a key table (e.g., which are subsequently masked to generate the masked key table 410) and/or randomness can be used to apply masking to the individual keys of a key table (e.g., as described with respect to the masking engine 250 of FIG. 2A) in order to obtain the masked key table 410. With randomness pushed to the key generation and/or key masking stages, the systems and techniques described herein can more efficiently implement subsequent steps of a cryptographic encryption or decryption process, as the subsequent steps can be used without external randomness, based on utilizing the deterministic randomness of the deterministic masking engine 420.

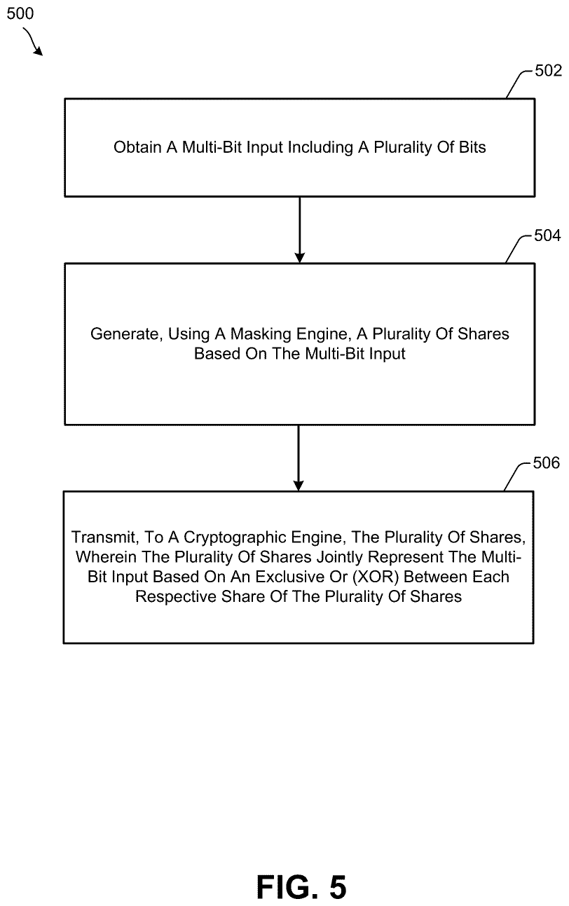

FIG. 5 is a flow diagram illustrating an example of a process 500 for data access, in accordance with aspects of the present disclosure. The process 500 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 500 may be implemented as software components that are executed and run on one or more processors.

At block 502, the process 500 includes obtaining a multi-bit input including a plurality of bits. In some examples, the multi-bit input can include at least four bits. In some cases, the multi-bit input is a first multi-bit share associated with a cryptographic key. In some aspects, the multi-bit input can be obtained from one or more of a processor (e.g., such as the processor 102 of FIG. 1), a cryptographic engine (e.g., such as the cryptographic engine 116 of FIG. 1), a memory device (e.g., such as the memory device 108 of FIG. 1), a universal flash storage (UFS) device (e.g., such as the UFS device 104 of FIG. 1), an additional storage device (e.g., such as the additional storage device 110 of FIG. 12), a security information asset storage device (e.g., such as the security information asset storage device 106 of FIG. 1), among various others.

In some examples, the multi-bit input comprises multiple plaintext bits of a cryptographic key or multiple plaintext bits of data. In some cases, the multi-bit input includes at least one random bit, the at least one random bit having a random value based on an external source of randomness. For example, the external source of randomness can be external to one or more (or both) of the masking engine and the cryptographic engine. In some cases, the multi-bit input includes at least one random bit obtained based on a random output of an Advanced Encryption Standard (AES) engine, such as the AES engine 250 of FIG. 2B and/or the AES engine 450 of FIG. 4.

At block 504, the process 500 includes generating, using a masking engine, a plurality of shares based on the multi-bit input. For example, the masking engine can be the same as or similar to the masking engine 210 of FIG. 2A. In some cases, the masking engine can be a deterministic masking engine. For instance, the masking engine can be the same as or similar to one or more (or both) of the deterministic masking engine 320 of FIG. 3 and/or the deterministic masking engine 420 of FIG. 4. In some cases, the masking engine is a deterministic masking engine included in a plurality of deterministic masking engines.

In some examples, the multi-bit input includes at least four bits and the plurality of shares generated using the masking engine includes at least four respective shares, each respective share including four respective bits. For example, the multi-bit input can be the same as or similar to the multi-bit input 305 of FIG. 3, the masking engine can be the same as or similar to the deterministic masking engine 320 of FIG. 3, and the plurality of shares can be the same as or similar to the shares 325 of FIG. 3. In some examples, each respective share includes the four respective bits and further includes at least one spare Hamming weight balancing bit (e.g., parity bit) corresponding to the four respective bits. For example, each respective share may comprise at least five bits (e.g., four bits representative of the share and one or more spare Hamming weight balancing bits (e.g., parity bits)).

In some cases, the plurality of shares have a constant Hamming weight. In some examples, the constant Hamming weight associated with the plurality of shares can be further associated with a constant toggle count (e.g., a constant toggle count in subsequent use(s) and/or application(s) of the plurality of shares. For example, the constant toggle count can be associated with a Hamming weight equal to the number of 1s in a binary representation of each share of the plurality of shares. In some cases, each respective share of the plurality of shares is generated in parallel. For example, a plurality of multi-bit shares can be generated corresponding to a multi-bit input, where each multi-bit share of the plurality of multi-bit shares is based on or otherwise influenced by each bit of the multi-bit input. In some cases, the masking engine (e.g., such as deterministic masking engine 320 of FIG. 3 and/or deterministic masking engine 420 of FIG. 4) can generate the plurality of shares (e.g., the shares 325 of FIG. 3) simultaneously or concurrently with one another, to correspond or jointly represent the multi-bit input (e.g., multi-bit input 305 of FIG. 3).

In some examples, the masking engine generates the plurality of shares based on receiving as input each respective bit of the plurality of bits included in the multi-bit input. For instance, each share of the plurality of shares can be jointly generated using each respective bit included in the multi-bit input. In some examples, the masking engine generates the plurality of shares without using a random bit and/or without using an external (and/or internal) source of randomness.

At block 506, the process 500 includes transmitting, to a cryptographic engine, the plurality of shares, wherein the plurality of shares jointly represent the multi-bit input based on an exclusive or (XOR) between each respective share of the plurality of shares. In some cases, transmitting the plurality of shares includes transmitting, using an exclusive hardware wired connection, a plurality of multi-bit shares indicative of an input value being masked and protected. For instance, the plurality of shares generated by the deterministic masking engine (e.g., deterministic masking engine 320 of FIG. 3, deterministic masking engine 420 of FIG. 4) can be transmitted to a cryptographic engine such as the AES engine 250 of FIG. 2B and/or the AES engine 450 of FIG. 4. The plurality of shares can be transmitted using an exclusive hardware wired connection. An exclusive hardware wired connection between the deterministic masking engine and the cryptographic engine can be used to transmit (from the deterministic masking engine to the cryptographic engine) a plurality of multi-bit shares indicative of an input value being masked and protected by the deterministic masking engine. The exclusive hardware wired connection can be a hardware wired connection (e.g., a wired, a printed circuit board (PCB) trace, etc.) between the deterministic masking engine and the cryptographic engine that is only used for communications and/or signal transmission between the deterministic masking engine and the cryptographic engine. In some aspects, the deterministic masking engine can be included in the cryptographic engine, and the exclusive hardware wired connection can be an internal connection of the cryptographic engine. In some examples, the deterministic masking engine can be external to the cryptographic engine, and the exclusive hardware wired connection can be an external connection of both the cryptographic engine and the deterministic masking engine.

In some cases, the multi-bit input can be a first multi-bit share associated with a cryptographic key. For instance, the multi-bit input can be the same as or similar to the first multi-bit share h associated with the cryptographic key k depicted in FIG. 4. In some cases, the masking engine generates at least four shares based on the first multi-bit share, wherein the at least four shares jointly represent the first multi-bit share associated with the cryptographic key based on an XOR between each respective share of the at least four shares. For instance, the masking engine can generate at least four shares that are the same as or similar to the four shares a, b, c, d generated based on the first multi-bit share h of FIG. 4, such that a XOR b XOR c XOR d=h.

In some cases, the process 500 can further include obtaining a second multi-bit share associated with the cryptographic key, wherein an XOR between the first multi-bit share and the second multi-bit share is indicative of the cryptographic key. For example, the second multi-bit share can be the same as or similar to the second multi-bit share g of FIG. 4, which is associated with the same cryptographic key k as the first multi-bit share h of FIG. 4, wherein h XOR g=k.

In some cases, a second masking engine different from the masking engine can be used to generate an additional at least four shares based on the second multi-bit share. For example, a second masking engine may be the same as or similar to the deterministic masking engine 320 of FIG. 3 and/or the deterministic masking engine 420 of FIG. 4. The second masking engine and the masking engine can be separate instances or hardware implementations of a same deterministic masking engine architecture. In some cases, the second masking engine can be used to generate an additional at least four shares that jointly represent to the second multi-bit input g of FIG. 4. For example, the additional at least four shares can jointly represent the second multi-bit share associated with the cryptographic key based on an XOR between each respective share of the additional at least four shares.

In some examples, a plaintext input can be encrypted with the cryptographic key based on a first internal share associated with the cryptographic engine and a second internal share associated with the cryptographic engine. For example, the first internal share can comprise an XOR between a first subset of the at least four shares and the plaintext input (e.g., the subset c, d of the four shares a, b, c, d of FIG. 4 and the plaintext input p of FIG. 4). The second internal share can comprise an XOR between a second subset of the at least four shares and the second multi-bit share (e.g., the subset a, b, of the four shares a, b, c, d of FIG. 4 and the second multi-bit share g of FIG. 4). In some examples, the first subset of the at least four shares includes two shares of the at least four shares and the second subset of the at least four shares includes at least two shares of the at least four shares, the second subset being different than the first subset.

In some examples, a deterministic update can be performed to generate an updated first multi-bit share associated with the cryptographic key and an updated second multi-bit share associated with the cryptographic key. In some aspects, the deterministic update can be performed using a second masking engine that is different from the masking engine. In some examples, the deterministic update can be performed using a deterministic masking engine that is the same as or similar to the deterministic masking engine 418 of FIG. 4. For instance, the first multi-bit share can be updated based on h+=b+d and the second multi-bit share can be updated based on g+=b+d. In some cases, the second masking engine can perform the deterministic update using the at least four shares generated by the masking engine (e.g., the at least four shares a, b, c, d generated by the deterministic masking engine 420 of FIG. 4).

The components of a device configured to perform the process 500 of FIG. 5 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 500 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

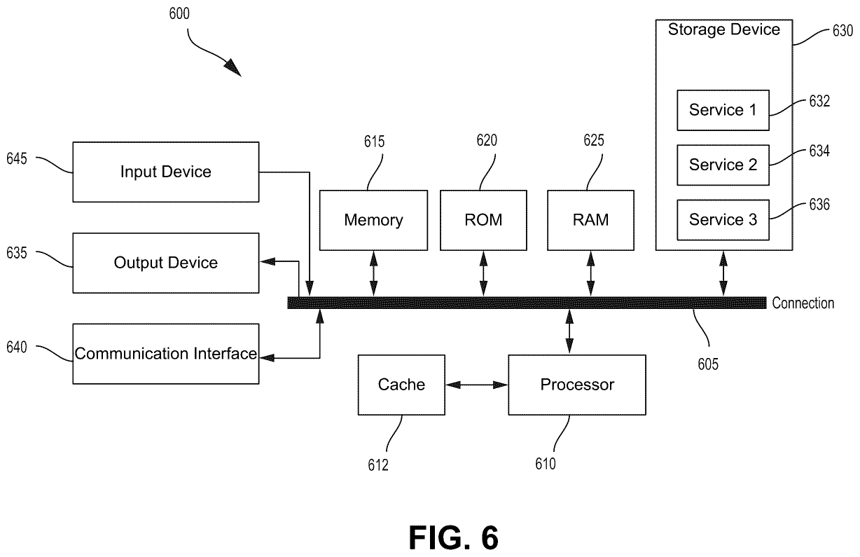

FIG. 6 is a block diagram illustrating an example of a computing system 600, which may be employed by the disclosed systems and techniques. In particular, FIG. 6 illustrates an example of computing system 600, which can be, for example, any computing device making up internal computing system, a remote computing system, a camera, or any component thereof in which the components of the system are in communication with each other using connection 605. Connection 605 can be a physical connection using a bus, or a direct connection into processor 610, such as in a chipset architecture. Connection 605 can also be a virtual connection, networked connection, or logical connection.

In some aspects, computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 600 includes at least one processing unit (CPU or processor) 610 and connection 605 that communicatively couples various system components including system memory 615, such as read-only memory (ROM) 620 and random-access memory (RAM) 625 to processor 610. Computing system 600 can include a cache 612 of high-speed memory connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms. In some instances, multimodal systems can enable a user to provide multiple types of input/output to communicate with computing system 600.

Computing system 600 can include communications interface 640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 640 may also include one or more range sensors (e.g., LIDAR sensors, laser range finders, RF radars, ultrasonic sensors, and infrared (IR) sensors) configured to collect data and provide measurements to processor 610, whereby processor 610 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some aspects, a hardware service that performs a particular function can include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A method for data access, comprising: obtaining a multi-bit input including a plurality of bits; generating, using a masking engine, a plurality of shares based on the multi-bit input; and transmitting, to a cryptographic engine, the plurality of shares, wherein the plurality of shares jointly represent the multi-bit input based on an exclusive or (XOR) between each respective share of the plurality of shares.

Aspect 2. The method of Aspect 1, wherein the plurality of shares have a constant toggle count, wherein the constant toggle count is associated with a Hamming weight equal to the number of Is in a binary representation of each share of the plurality of shares.

Aspect 3. The method of any of Aspects 1 to 2, wherein transmitting the plurality of shares includes transmitting, using an exclusive hardware wired connection, a plurality of multi-bit shares indicative of an input value being masked and protected.

Aspect 4. The method of any of Aspects 1 to 3, wherein each respective share of the plurality of shares is generated in parallel.

Aspect 5. The method of any of Aspects 1 to 4, wherein the masking engine generates the plurality of shares based on receiving as input each respective bit of the plurality of bits included in the multi-bit input.

Aspect 6. The method of Aspect 5, wherein each share of the plurality of shares is jointly generated using each respective bit included in the multi-bit input.

Aspect 7. The method of any of Aspects 1 to 6, wherein the masking engine generates the plurality of shares without using a random bit.

Aspect 8. The method of any of Aspects 1 to 7, wherein: the multi-bit input includes at least four bits; and the plurality of shares includes at least four respective shares, each respective share including four respective bits.

Aspect 9. The method of Aspect 8, wherein each respective share includes the four respective bits and further includes at least one spare Hamming weight balancing bit corresponding to the four respective bits.

Aspect 10. The method of any of Aspects 1 to 9, wherein: the multi-bit input is a first multi-bit share associated with a cryptographic key; and the masking engine generates at least four shares based on the first multi-bit share, wherein the at least four shares jointly represent the first multi-bit share associated with the cryptographic key based on an XOR between each respective share of the at least four shares.

Aspect 11. The method of Aspect 10, further comprising: obtaining a second multi-bit share associated with the cryptographic key, wherein an XOR between the first multi-bit share and the second multi-bit share is indicative of the cryptographic key.

Aspect 12. The method of Aspect 11, further comprising: generating, using a second masking engine different from the masking engine, an additional at least four shares based on the second multi-bit share, wherein the additional at least four shares jointly represent the second multi-bit share associated with the cryptographic key based on an XOR between each respective share of the additional at least four shares.

Aspect 13. The method of any of Aspects 11 to 12, further comprising encrypting a plaintext input with the cryptographic key based on a first internal share associated with the cryptographic engine and a second internal share associated with the cryptographic engine, wherein: the first internal share comprises an XOR between a first subset of the at least four shares and the plaintext input; and the second internal share comprises an XOR between a second subset of the at least four shares and the second multi-bit share.

Aspect 14. The method of Aspect 13, wherein: the first subset of the at least four shares includes two shares of the at least four shares; and the second subset of the at least four shares includes at least two shares of the at least four shares, the second subset different than the first subset.

Aspect 15. The method of any of Aspects 13 to 14, further comprising performing a deterministic update to generate an updated first multi-bit share associated with the cryptographic key and an updated second multi-bit share associated with the cryptographic key, wherein the deterministic update is performed using a second masking engine different from the masking engine.

Aspect 16. The method of Aspect 15, further comprising performing a deterministic update of a secret key in masked form based on re-using four shares generated by a masking engine from one of the shares.

Aspect 17. The method of any of Aspects 1 to 16, wherein the masking engine is a deterministic masking engine included in a plurality of deterministic masking engines.

Aspect 18. The method of any of Aspects 1 to 17, wherein the multi-bit input comprises multiple plaintext bits of a cryptographic key or multiple plaintext bits of data.

Aspect 19. The method of Aspect 18, wherein the multi-bit input includes at least one random bit, the at least one random bit having a random value based on an external source of randomness.

Aspect 20. The method of any of Aspects 18 to 19, wherein the multi-bit input includes at least one pseudo-random bit obtained from a cipher-text output of an Advanced Encryption Standard (AES) engine.

Aspect 21. An apparatus for data access, comprising: at least one memory; and at least one processor coupled to the at least one memory, the at least one processor configured to: obtain a multi-bit input including a plurality of bits; generate, using a masking engine, a plurality of shares based on the multi-bit input; and transmit, to a cryptographic engine, the plurality of shares, wherein the plurality of shares jointly represent the multi-bit input based on an exclusive or (XOR) between each respective share of the plurality of shares.

Aspect 22. The apparatus of Aspect 21, wherein the plurality of shares have a constant toggle count, wherein the constant toggle count is associated with a Hamming weight equal to the number of 1s in a binary representation of each share of the plurality of shares.

Aspect 23. The apparatus of any of Aspects 21 to 22, wherein, to transmit the plurality of shares, the at least one processor is configured to transmit, using an exclusive hardware wired connection, a plurality of multi-bit shares indicative of an input value being masked and protected.

Aspect 24. The apparatus of any of Aspects 21 to 23, wherein the at least one processor is configured to generate each respective share of the plurality of shares in parallel.

Aspect 25. The apparatus of any of Aspects 21 to 24, wherein the at least one processor is configured to generate, using the masking engine, the plurality of shares based on receiving as input each respective bit of the plurality of bits included in the multi-bit input.

Aspect 26. The apparatus of Aspect 25, wherein the at least one processor is configured to jointly generate each share of the plurality of shares using each respective bit included in the multi-bit input.

Aspect 27. The apparatus of any of Aspects 21 to 26, wherein the at least one processor is configured to generate the plurality of shares without using any random bits.

Aspect 28. The apparatus of any of Aspects 21 to 27, wherein: the multi-bit input includes at least four bits; and the plurality of shares includes at least four respective shares, each respective share including four respective bits.

Aspect 29. The apparatus of Aspect 28, wherein each respective share includes the four respective bits and further includes at least one additional spare bit corresponding to the four respective bits, wherein the at least one additional spare bit is not used for the respective share and can implement a constant Hamming weight, and wherein the at least one additional spare bit can be a parity bit.

Aspect 30. The apparatus of Aspect 29, wherein each respective share includes additional spare bits that can be used to remove statistical bias.

Aspect 31. The apparatus of any of Aspects 29 to 30, wherein each respective share includes additional spare bits that can be used to compensate statistical correlations associated with leaking information of a secret value of the multi-bit input.

Aspect 32. The apparatus of any of Aspects 21 to 31, wherein: the multi-bit input is a first multi-bit share associated with a cryptographic key; and the at least one processor is configured to generate, using the masking engine, at least four shares based on the first multi-bit share, wherein the at least four shares jointly represent the first multi-bit share associated with the cryptographic key based on an XOR between each respective share of the at least four shares.

Aspect 33. The apparatus of Aspect 32, wherein the at least one processor is further configured to: obtain a second multi-bit share associated with the cryptographic key, wherein an XOR between the first multi-bit share and the second multi-bit share is indicative of the cryptographic key.

Aspect 34. The apparatus of Aspect 33, wherein the at least one processor is further configured to: generate, using a second masking engine different from the masking engine, an additional at least four shares based on the second multi-bit share, wherein the additional at least four shares jointly represent the second multi-bit share associated with the cryptographic key based on an XOR between each respective share of the additional at least four shares.

Aspect 35. The apparatus of any of Aspects 33 to 34, wherein the at least one processor is further configured to encrypt a plaintext input with the cryptographic key based on a first internal share associated with the cryptographic engine and a second internal share associated with the cryptographic engine, wherein: the first internal share comprises an XOR between a first subset of the at least four shares and the plaintext input; and the second internal share comprises an XOR between a second subset of the at least four shares and the second multi-bit share.

Aspect 36. The apparatus of Aspect 35, wherein: the first subset of the at least four shares includes two shares of the at least four shares; and the second subset of the at least four shares includes at least two shares of the at least four shares, the second subset different than the first subset.

Aspect 37. The apparatus of any of Aspects 35 to 36, wherein the at least one processor is further configured to: perform a deterministic update to generate an updated first multi-bit share associated with the cryptographic key and an updated second multi-bit share associated with the cryptographic key, wherein the deterministic update is performed using a second masking engine different from the masking engine.

Aspect 38. The apparatus of any of Aspects 21 to 37, wherein the masking engine is a deterministic masking engine included in a plurality of deterministic masking engines.

Aspect 39. The apparatus of any of Aspects 21 to 38, wherein the multi-bit input comprises multiple plaintext bits of a cryptographic key or multiple plaintext bits of data.

Aspect 40. The apparatus of any of Aspects 21 to 39, wherein the multi-bit input includes at least one random bit, the at least one random bit having a random value based on an external source of randomness.

Aspect 41. The apparatus of any of Aspects 21 to 40, wherein the multi-bit input includes at least one pseudo-random bit obtained from a ciper-text output of an Advanced Encryption Standard (AES) engine.

Aspect 42. The method of any of Aspects 2 to 20, wherein each respective share of the plurality of shares is a multi-bit share and includes one or more additional data bits, wherein the one or more additional data bits are adjusted to implement a constant Hamming weight for each multi-bit share.

Aspect 43. The apparatus of any of Aspects 22 to 41, wherein each respective share of the plurality of shares is a multi-bit share and includes one or more additional data bits, wherein the one or more additional data bits are adjusted to implement a constant Hamming weight for each multi-bit share.

Aspect 44. A non-transitory computer-readable medium including instructions which, when executed by one or more processors, cause the one or more processors to perform operations according to any of Aspects 1 to 20.

Aspect 45. A non-transitory computer-readable medium including instructions which, when executed by one or more processors, cause the one or more processors to perform operations according to any of Aspects 21 to 41.

Aspect 46. An apparatus comprising one or more means for performing operations according to any of Aspects 1 to 20.

Aspect 47. An apparatus comprising one or more means for performing operations according to any of Aspects 21 to 41.

What is claimed is:

1. A method for data access, comprising:
obtaining a multi-bit input including a plurality of bits;
generating, using a masking engine, a plurality of shares based on the multi-bit input; and
transmitting, to a cryptographic engine, the plurality of shares, wherein the plurality of shares jointly represent the multi-bit input based on an exclusive or (XOR) between each respective share of the plurality of shares.

2. The method of claim 1, wherein the plurality of shares have a constant toggle count, wherein the constant toggle count is associated with a Hamming weight equal to the number of 1s in a binary representation of each share of the plurality of shares.

3. The method of claim 2, wherein each respective share of the plurality of shares is a multi-bit share and includes one or more additional data bits, wherein the one or more additional data bits are adjusted to implement a constant Hamming weight for each multi-bit share.

4. The method of claim 1, wherein transmitting the plurality of shares includes transmitting, using an exclusive hardware wired connection, a plurality of multi-bit shares indicative of an input value being masked and protected.

5. The method of claim 1, wherein each respective share of the plurality of shares is generated in parallel.

6. The method of claim 1, wherein the masking engine generates the plurality of shares based on receiving as input each respective bit of the plurality of bits included in the multi-bit input.

7. The method of claim 6, wherein each share of the plurality of shares is jointly generated using each respective bit included in the multi-bit input.

8. The method of claim 1, wherein the masking engine generates the plurality of shares without using any random bits.

9. The method of claim 1, wherein:
the multi-bit input includes at least four bits; and
the plurality of shares includes at least four respective shares, each respective share including four respective bits.

10. The method of claim 9, wherein each respective share includes the four respective bits and further includes at least one spare Hamming weight balancing bit corresponding to the four respective bits.

11. The method of claim 1, wherein:
the multi-bit input is a first multi-bit share associated with a cryptographic key; and
the masking engine generates at least four shares based on the first multi-bit share, wherein the at least four shares jointly represent the first multi-bit share associated with the cryptographic key based on an XOR between each respective share of the at least four shares.

12. The method of claim 11, further comprising:
obtaining a second multi-bit share associated with the cryptographic key, wherein an XOR between the first multi-bit share and the second multi-bit share is indicative of the cryptographic key.

13. The method of claim 12, further comprising:
generating, using a second masking engine different from the masking engine, an additional at least four shares based on the second multi-bit share, wherein the additional at least four shares jointly represent the second multi-bit share associated with the cryptographic key based on an XOR between each respective share of the additional at least four shares.

14. The method of claim 12, further comprising encrypting a plaintext input with the cryptographic key based on a first internal share associated with the cryptographic engine and a second internal share associated with the cryptographic engine, wherein:
the first internal share comprises an XOR between a first subset of the at least four shares and the plaintext input; and
the second internal share comprises an XOR between a second subset of the at least four shares and the second multi-bit share.

15. The method of claim 14, wherein:
the first subset of the at least four shares includes two shares of the at least four shares; and
the second subset of the at least four shares includes at least two shares of the at least four shares, the second subset different than the first subset.

16. The method of claim 14, further comprising performing a deterministic update to generate an updated first multi-bit share associated with the cryptographic key and an updated second multi-bit share associated with the cryptographic key, wherein the deterministic update is performed using a second masking engine different from the masking engine.

17. The method of claim 16, further comprising performing a deterministic update of a secret key in a masked form based on re-using four shares generated by a masking engine from one of the shares.

18. The method of claim 1, wherein the masking engine is a deterministic masking engine included in a plurality of deterministic masking engines.

19. The method of claim 1, wherein the multi-bit input comprises multiple plaintext bits of a cryptographic key or multiple plaintext bits of data.

20. The method of claim 19, wherein the multi-bit input includes at least one random bit, the at least one random bit having a random value based on an external source of randomness.

21. The method of claim 29, wherein the multi-bit input includes at least one pseudo-random bit obtained from a cipher-text output of an Advanced Encryption Standard (AES) engine.

22. An apparatus for data access, comprising:
at least one memory; and
at least one processor coupled to the at least one memory, the at least one processor configured to:
obtain a multi-bit input including a plurality of bits;
generate, using a masking engine, a plurality of shares based on the multi-bit input; and
transmit, to a cryptographic engine, the plurality of shares, wherein the plurality of shares jointly represent the multi-bit input based on an exclusive or (XOR) between each respective share of the plurality of shares.

23. The apparatus of claim 22, wherein the plurality of shares have a constant toggle count, wherein the constant toggle count is associated with a Hamming weight equal to the number of 1s in a binary representation of each share of the plurality of shares.

24. The apparatus of claim 22, wherein, to transmit the plurality of shares, the at least one processor is configured to transmit, using an exclusive hardware wired connection, a plurality of multi-bit shares indicative of an input value being masked and protected.

25. The apparatus of claim 22, wherein the at least one processor is configured to jointly generate each share of the plurality of shares using each respective bit included in the multi-bit input.

26. The apparatus of claim 22, wherein the at least one processor is configured to generate the plurality of shares without using any random bits.

27. The apparatus of claim 22, wherein:
the multi-bit input is a first multi-bit share associated with a cryptographic key; and
the at least one processor is configured to generate, using the masking engine, at least four shares based on the first multi-bit share, wherein the at least four shares jointly represent the first multi-bit share associated with the cryptographic key based on an XOR between each respective share of the at least four shares.

28. The apparatus of claim 27, wherein the at least one processor is further configured to:
obtain a second multi-bit share associated with the cryptographic key, wherein an XOR between the first multi-bit share and the second multi-bit share is indicative of the cryptographic key.

29. The apparatus of claim 28, wherein the at least one processor is further configured to encrypt a plaintext input with the cryptographic key based on a first internal share associated with the cryptographic engine and a second internal share associated with the cryptographic engine, wherein:
the first internal share comprises an XOR between a first subset of the at least four shares and the plaintext input; and
the second internal share comprises an XOR between a second subset of the at least four shares and the second multi-bit share.

30. The apparatus of claim 29, wherein:
the first subset of the at least four shares includes two shares of the at least four shares; and
the second subset of the at least four shares includes at least two shares of the at least four shares, the second subset different than the first subset.
